(19) United States
(12) Patent Application Publication
(10) Pub. No.: US 2025/0208851 A1
(43) Pub. Date: Jun. 26, 2025

(54) SYSTEM AND APPARATUS SUITABLE FOR FACILITATING VEHICLE SYSTEM UPDATE, AND A PROCESSING METHOD IN ASSOCIATION THERETO

(71) Applicant: Continental Automotive Technologies GmbH, Hannover (DE)

(72) Inventors: Kawshol Devilal Sharma, Singapore (SG); Mintak Lee, Singapore (SG); Chong Hin Liew, Singapore (SG); Lee Lee Chua, Singapore (SG); Chengnan Jin, Kawasaki (JP); Munro Biswal, Lake Zurich, IL (US)

(73) Assignee: Continental Automotive Technologies GmbH, Hannover (DE)

(21) Appl. No.: 18/852,063

(22) PCT Filed: Mar. 27, 2023
(86) PCT No.: PCT/EP2023/057769

§ 371 Date: Sep. 27, 2024

(30) Foreign Application Priority Data
Mar. 31, 2022 (GB) 2204619.7

(51) Int. Cl. G06F 8/65; G06F 1/3234

(52) U.S. Cl. CPC G06F 8/65; G06F 1/3234

(57) ABSTRACT

A vehicle is updated during a vehicle ignition off state via a determination step, a processing step and/or a power conservation step. The determination step can include communicating at least one request signal. Based on the request signal(s), availability of at least one update package can be determined. When it can be determined that at least one update package is available, one or more data signals corresponding to the update package(s) can be communicated. The processing step can include processing the data signal(s) in a manner so that the vehicle can be updated, if it is determined that one or more update packages are available. The power conservation step can include switching between the wake-up mode and the power saving mode so as to reduce current consumption in connection with vehicle update during the vehicle ignition off state.

### CROSS-REFERENCE TO RELATED APPLICATIONS

The present application is a National Stage Application under 35 U.S.C. § 371 of International Patent Application No. PCT/EP2023/057769 filed on Mar. 27, 2023, and claims priority from Great Britain Patent Application No. 2204619.7 filed on Mar. 31, 2022, in the United Kingdom Intellectual Property Office, the disclosures of which are herein incorporated by reference in their entireties.

### FIELD OF INVENTION

The present disclosure generally relates to one or both of a system and an apparatus suitable for updating a system which can be associated with, for example, a vehicle. More specifically, the present disclosure relates to a system and/or an apparatus suitable for updating one or more portions of the vehicle operating system during the time/period the vehicle engine is turned off/switched off. The present disclosure further relates a processing method associable to the system and/or the apparatus.

### BACKGROUND

Generally, a vehicle may carry one or more electronic components/modules. Such electronic components/modules can be associated with software necessary for control of hardware operation(s) etc. In this regard, it is appreciable that a vehicle can be associated with an operating system in connection with such software. The vehicle operating system can, for example, be carried by a processor which can be carried by the vehicle.

Appreciably, it may be necessary to periodically update one or more portions of the vehicle operating system. Update of one or more portions of the vehicle operating system usually occurs when the vehicle engine is turned on/switched on.

However, during updating, it is possible that vehicle operationality may be affected. For example, one or more hardware components/modules (e.g., car radio/infotainment unit, wipers, one or more sensors and/or control modules) of the vehicle may not be capable of functioning and/or functioning as required. Hence it may be possible that a vehicle cannot be operated (e.g., driven) during updating, and this may not be user-friendly. Moreover, even during updating at, for example, a designated location (e.g., vehicle service center/workshop), it is appreciable that the engine is essentially left idling, and this may not be efficient (e.g., not fuel efficient).

Therefore, the present disclosure contemplates that current updates (of a vehicle) are not performed in a user-friendly manner and/or in an efficient manner, and there is a need to address (or at least mitigate) such an issue/issues.

### BRIEF SUMMARY

In accordance with an aspect of the disclosure, there is provided an apparatus which can, for example, be suitable for use with a vehicle. In one example, there is provided an apparatus which can be suitable for use for updating a vehicle, in accordance with an embodiment of the disclosure. In a more specific example, there is provided an apparatus which can be suitable for updating a vehicle during the vehicle ignition off state, in accordance with an embodiment of the disclosure.

The apparatus can initially be in a power saving mode when the vehicle is in the ignition off state. Moreover, the apparatus can be configured to switch between a wake-up mode and the power saving mode. It is appreciable that in the power saving mode, for example, current consumption can be lower as compared to, for example, current consumption during the wake-up mode. In this regard, it is appreciable that, for example, current consumption, during the power saving mode, can be considered to be reduced (i.e., as compared with \current consumption during the wake-up mode).

The apparatus can include a first module and a second module, in accordance with an embodiment of the disclosure. The first module can be coupled to the second module.

The first module can be configured to communicate one or more request signals when the apparatus is switched from the power saving mode to the wake-up mode. Based on the request signal(s), availability of at least one update package can be determined. When availability of an update package is determined (e.g., one or more update packages are available for download), one or more data signals corresponding to the update package can be communicated. When unavailability of an update package is determined (e.g., it is determined that there are no update packages for download), the apparatus can be switched from the wake-up mode to the power saving mode.

The second module can be configured to process the data signal(s), when availability of an update package is determined, in a manner so that the vehicle can be updated.

Moreover, the apparatus can be configured to switch from the wake-up mode to the power saving mode after the vehicle has been updated. In one embodiment, the apparatus can initially be switched between the power saving mode and the wake-up mode periodically (e.g., based on a predetermined time-period/frame).

It is contemplated that the apparatus can be coupled to a device (e.g., a backend server) which can be capable of carrying at least one update package. The request signal(s) can be communicated from, for example, the first module to the device. Based on the request signal(s), the device can be configured to communicate the update package(s), if there are one are more update packages available for download. In one embodiment, the update package(s) can be communicated via a communication network, for example, through an authenticated access point. The communication network can, for example, correspond one or both of a cellular-based network and a Wi-Fi-based network (i.e., a cellular-based network and/or a Wi-Fi based network).

In the above manner, it is appreciable that updating can possibly be facilitated/performed during the time/period when a vehicle engine is turned/switched off (i.e., “ignition off”). Hence, updating need not necessarily be performed whilst the vehicle engine is turned/switched on (i.e., during “ignition on”) and vehicle functionality/functionalities whilst vehicle is in operation (e.g., when being driven) would not be necessarily be substantially adversely affected/impacted. In this regard, it is appreciable that updating can possibly be performed/facilitated in a (more) user friendly manner. Moreover, updating can be performed without the vehicle engine being left idling and, hence, updating can possibly be performed in a (more) efficient manner (e.g., in a more fuel/energy efficient manner).

Moreover, in the above manner (e.g., based on appropriate switching between the power saving mode and the wake-up mode), it is contemplated that current consumption during updating whilst “ignition off” can possibly be at least substantially reduced. Hence, the possibility of the vehicle battery being depleted during updating (e.g., due to high current consumption during updating) whilst “ignition off” can at least be substantially reduced.

The above-described advantageous aspect(s) of the apparatus of the present disclosure can also apply analogously (all) the aspect(s) of a below described processing method of the present disclosure. Likewise, all below described advantageous aspect(s) of the processing method of the disclosure can also apply analogously (all) the aspect(s) of above described apparatus of the disclosure.

In accordance with an aspect of the disclosure, there is provided a processing method suitable for use with a vehicle. In an example, the processing method can be used for updating a vehicle, in accordance with an embodiment of the disclosure. In a more specific example, the processing method can be suitable for use for updating a vehicle during the vehicle ignition off state.

The processing method can include any one of a determination step, a processing step and a power conservation step, or any combination thereof. In one embodiment, the processing method can include a determination step, a processing step and a power conservation step.

The determination step can include communicating one or more request signals. The request signal(s) can, for example, be communicated by the first module of the earlier mentioned apparatus. Based on the at least one request signal, availability of one or more update packages can be determined (e.g., whether one or more update packages are available for download). When it can be determined that at least one update package is available (e.g., for download), one or more data signals corresponding to the update package(s) can be communicated. In one embodiment, the apparatus can, for example, initially in a power saving mode when the vehicle is in the ignition off state. Moreover, in one embodiment, the apparatus can, for example, be configured to switch between a wake-up mode and the power saving mode. In one embodiment, the first module can be configured to communicate the request signal(s) when the apparatus is switched from the power saving mode to the wake-up mode.

The processing step can include processing the data signal(s) in a manner so that the vehicle can be updated, if it is determined that one or more update packages are available. The data signal(s) can, for example, be processed by the second module of the earlier mentioned apparatus.

The power conservation step can include switching between the wake-up mode and the power saving mode so as to reduce current consumption in connection with vehicle update during the vehicle ignition off state.

In one embodiment, the processing method can further include an update step which can include updating the vehicle based on the data signal(s) if at least one update package is determined to be available.

i.

Moreover, in one embodiment, the update package(s) can be communicated via a communication network, for example, through an authenticated access point. The communication network can, for example, correspond to one or both of a cellular-based network and a Wi-Fi-based network (i.e., a cellular-based network and/or a Wi-Fi-based network), in accordance with an embodiment of the disclosure.

The present disclosure further contemplates a computer program which can include instructions which, when the program is executed by a computer, cause the computer to carry out any one of, or any combination of, the determination step, the processing step and the power conservation step (and, optionally, the update step), as discussed with reference to the processing method.

The present disclosure yet further contemplates a computer readable storage medium having data stored therein representing software executable by a computer, the software including instructions, when executed by the computer, to carry out any one of, or any combination of, the determination step, the processing step and the power conservation step (and, optionally, the update step), as discussed with reference to the processing method.

In the above manner, it is appreciable that updating can possibly be facilitated/performed during the time/period when a vehicle engine is turned/switched off (i.e., “ignition off”). Hence, updating need not necessarily be performed whilst the vehicle engine is turned/switched on (i.e., during “ignition on”) and vehicle functionality/functionalities whilst vehicle is in operation (e.g., when being driven) would not be necessarily be substantially adversely affected/impacted. In this regard, it is appreciable that updating can possibly be performed/facilitated in a (more) user friendly manner. Moreover, updating can be performed without the vehicle engine being left idling and, hence, updating can possibly be performed in a (more) efficient manner (e.g., in a more fuel/energy efficient manner).

Moreover, in the above manner (e.g., based on appropriate switching between the power saving mode and the wake-up mode), it is contemplated that current consumption during updating whilst “ignition off” can possibly be at least substantially reduced. Hence, the possibility of the vehicle battery being depleted during updating (e.g., due to high current consumption during updating) whilst “ignition off” can at least be substantially reduced.

### BRIEF DESCRIPTION OF THE DRAWINGS

Embodiments of the disclosure are described hereinafter with reference to the following drawings.

FIG. 1 shows a system which can include at least one apparatus, according to an embodiment of the disclosure.

FIG. 2 shows the apparatus of FIG. 1 in further detail, according to an embodiment of the disclosure.

FIG. 3 shows a processing method in association with the system of FIG. 1, according to an embodiment of the disclosure.

### DETAILED DESCRIPTION

The present disclosure contemplates that to perform updating in possibly a (more) user friendly manner and/or a (more) efficient manner, updating can be performed during the time/period when a vehicle engine is turned/switched off. The time/period when a vehicle is turned off/switched off can, for example, generally/simply be referable to as “ignition off”.

By doing so, operationality of a vehicle would be least likely affected when the vehicle is being operated (e.g., driven) and/or the vehicle engine would not be left in an idling state during updating. Therefore, updating can be performed in possibly a (more) user friendly manner and/or a (more) efficient manner.

However, the present disclosure contemplates that updating during the time/period when a vehicle engine is turned/switched off, may possibly deplete the vehicle battery due to high current consumption during updating. This (i.e., a depleted vehicle battery) may cause the inability of the vehicle engine to restart and is not desirable.

The present disclosure contemplates that a solution to at least mitigate the possibility of vehicle battery depletion would be necessary to facilitate updating being performed during ignition off.

Generally, the present disclosure contemplates a system and apparatus suitable for facilitating vehicle system update during ignition off, and a processing method in association to one or both of the system and the apparatus.

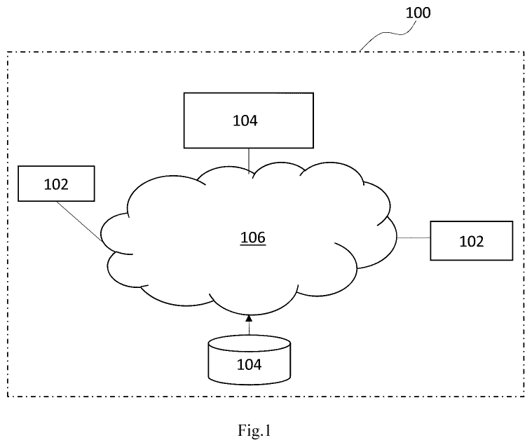

The foregoing will be discussed in further detail with reference to FIG. 1 to FIG. 3 hereinafter.

Referring to FIG. 1, a system 100 is shown, according to an embodiment of the disclosure. The system 100 can be suitable for use in connection with/be associated with a vehicle (not shown). Specifically, the system 100 can be associated with a vehicle, in accordance with an embodiment of the disclosure. More specifically, in association with a vehicle, the system 100 can be suitable for use for updating one or more portions of the vehicle operating system, in accordance with an embodiment of the disclosure. Yet more specifically, the system 100 can be suitable for use for updating software associated with a vehicle, in accordance with an embodiment of the disclosure.

It is contemplated that updating can, for example, be performed “over the air” (OTA) whilst the vehicle is in an “ignition off” state, in accordance with an embodiment of the disclosure. Specifically, OTA-based updating can be performed during ignition off, in accordance with an embodiment of the disclosure.

In one embodiment, the system 100 can, for example, correspond to an electronic-based system which can be at least partially carried (e.g., the system being installed) by a, for example, vehicle (not shown). In one example, the system 100 can be fully (i.e., the entire system 100) carried by a vehicle. In another example, one or more portions of the system 100 can be carried by a vehicle whereas another one or more portions of the system 100 can be carried outside of the vehicle (e.g., at least one portion of the system 100 is not carried by the vehicle).

The system 100 can, for example, include one or more apparatuses 102, at least one device 104 and a communication network 106, in accordance with an embodiment of the disclosure.

The apparatus(es) 102 can be coupled to the device(s) 104. Specifically, the apparatus(es) 102 can, for example, be coupled to the device(s) 104 via the communication network 106.

In one embodiment, the apparatus(es) 102 can be coupled to the communication network 106 and the device(s) 104 can be coupled to the communication network 106. Coupling can be by manner of one or both of wired coupling and wireless coupling.

The apparatus(es) 102 can, in general, be configured to communicate with the device(s) 104 via the communication network 106, according to an embodiment of the disclosure.

The apparatus(es) 102 can, for example, correspond to one or more computers (e.g., an electronic device/module having computing capabilities such as an electronic mobile device which can be carried into a vehicle or an electronic module which can be installed in a vehicle). Generally, the apparatus(es) 102 can, in one embodiment, be configured to perform one or more processing tasks. As a general example, the apparatus(es) 102 can be configured to generate one or more request signals and communicate the request signal(s). Moreover, the apparatus(es) 102 can be configured to perform one or more updating-related processing tasks in association with updating of the vehicle. The apparatus(es) 102 will be discussed later in further detail with reference to FIG. 2, according to an embodiment of the disclosure.

The device(s) 104 can, for example, correspond to/be representative of at least one update system such as a backend server capable of carrying one or more update packages (e.g., an OTA package). The update package(s) be associated with one or more software package(s) for the aforementioned updating. One or more data signals corresponding to the update package(s) can be communicated from the device(s) 104, in accordance with an embodiment of the disclosure.

The communication network 106 can, for example, correspond to an Internet communication network, a wired-based communication network, a wireless-based communication network, or any combination thereof. Communication (i.e., between the apparatus(es) 102 and the device(s) 104) via the communication network 106 can be by manner of one or both of wired communication and wireless communication. The communication network 106 can, for example correspond to one or both of a cellular communication network and a Wi-Fi-based communication network, in accordance with an embodiment of the disclosure.

Earlier mentioned, the apparatus(es) 102 can be configured to generate and communicate one or more request signals.

The request signal(s) can be communicated from the apparatus(es) 102 to the device(s) 104. Based on the request signal(s), the device(s) 104 can be configured to communicate one or more data signals, if one or more update packages is/are available for communication. This will be discussed in further detail in the context of an example implementation hereinafter.

In regard to the example implementation, the apparatus(es) 102 can include/carry a data communication module (DCM) and one or both of at least one center engine/electronic control unit (C-ECU) and at least one ECU. The device(s) 104 can correspond to/be associated with a backend server capable of carrying one or more OTA packages. The network 106 can include/be associated with an access point (AP). Moreover, the network 106 can be associated with/correspond to a cellular network and/or a Wi-Fi-based network.

In the example implementation, during the “ignition off” (IGN Off) state of a vehicle, the DCM can enter a discontinuous reception (DRX) mode. During the DRX mode, it is appreciable that current consumption can be considered to be at a minimum (i.e., lowest current consumption). In this regard, when in the DRX mode, the apparatus(es) 102 can be considered to be in a power saving mode. The DCM can be configured to periodically connect to the network 106. For example, the DCM can be activated (i.e., to be in a “wake-up” state) periodically when an internal timer (e.g., which can be carried by the apparatus(es) 102) reaches a preset value. In this regard, when the DCM is activated, the apparatus(es) 102 can be considered to be in a wake-up mode. Therefore, it is appreciable that the apparatus(es) 102 can be initially be in the power saving mode during ignition off. It is further appreciable that the apparatus(es) 102 can be configured to switch between the power saving mode and the wake-up mode during ignition off.

In one example, the DCM, when in a “wake-up” state, can be configured to connect to a backend server via a cellular network and check (e.g., by manner of communicating one or more request signals) whether at least one OTA package is available for communication (i.e., for the purpose of updating). In another example, the DCM, when in a “wake-up” state, can be configured to connect to a backend server via a Wi-Fi-based network (e.g., via an authenticated AP over Wi-Fi) and check (e.g., by manner of communicating one or more request signals) whether at least one OTA package is available for communication (i.e., for the purpose of updating). In yet another example, the DCM, when in a “wake-up” state, can be configured to connect to a backend server via a combination of a Wi-Fi-based network and a cellular network, and check (e.g., by manner of communicating one or more request signals) whether at least one OTA package is available for communication (i.e., for the purpose of updating).

If it can be determined that no OTA packages are available for communication, it can be determined that OTA update would not be required and the DCM can then return to the DRX mode. Conversely, if it is determined that at least one OTA package is available for download, it can be determined that an OTA update would be required and the DCM can then be configured to enable communication via a Wi-Fi-based network via an authenticated AP. Moreover, when it can be determined that an OTA update is required, the DCM can be configured to activate (e.g., “wake up”) the C-ECU which can manage software download of each connected ECUs. When the C-ECU is ready a software download request (e.g., to down one or more available OTA packages) can be communicated (e.g., by manner of communicating the request signal(s)). For example, the DCM can be configured to send a software download request via a connected AP and the OTA package(s) can be downloaded from the backend server using Wi-fi via the authenticated AP. Upon completion of software download (i.e., fulfillment of the software download request), the DCM can enter a “power saving” mode by manner of disabling unnecessary functions (e.g., Wi-Fi connection) and, for example, returning to the DRX mode.

In the above manner, it is appreciable that updating can possibly be facilitated/performed during the time/period when a vehicle engine is turned/switched off (i.e., “ignition off”). Hence, updating need not necessarily be performed whilst the vehicle engine is turned/switched on (i.e., during “ignition on”) and vehicle functionality/functionalities whilst vehicle is in operation (e.g., when being driven) would not be necessarily be substantially adversely affected/impacted. In this regard, it is appreciable that updating can possibly be performed/facilitated in a (more) user friendly manner. Moreover, updating can be performed without the vehicle engine being left idling and, hence, updating can possibly be performed in a (more) efficient manner (e.g., in a more fuel/energy efficient manner).

Moreover, in the above manner, it is contemplated that current consumption during updating whilst “ignition off” can possibly be at least substantially reduced. Hence, the possibility of the vehicle battery being depleted (e.g., due to high current consumption during updating) can at least be substantially reduced.

The aforementioned apparatus(es) 102 will be discussed in further detail with reference to FIG. 2 hereinafter.

Referring to FIG. 2, an apparatus 102 is shown in further detail in the context of an exemplary implementation 200, according to an embodiment of the disclosure.

In the exemplary implementation 200, the apparatus 102 can carry any one of a first module 202, a second module 204, a third module 206, or any combination thereof.

In one embodiment, the apparatus 102 can carry a first module 202, a second module 204 and, optionally, a third module 206. In a specific example, the apparatus 102 can carry a first module 202, a second module 204 and a third module 206. In another specific example, the apparatus 102 can carry a first module 202 and a second module 204.

The first module 202 can be coupled to one or both of the second module 204 and the third module 206. The second module 204 can be coupled to one or both of the first module 202 and the third module 206. The third module 206 can be coupled to one or both of the first module 202 and the second module 204. Coupling between the first module 202, the second module 204 and/or the third module 206 can, for example, be by manner of one or both of wired coupling and wireless coupling. Each of the first module 202, the second module 204 and the third module 206 can correspond to one or both of a hardware-based module and a software-based module, according to an embodiment of the disclosure.

In one example, the first module 202 can correspond to a hardware-based module (e.g., a transmitter) which can be configured to communicate the request signal(s).

The second module 204 can, for example, correspond to a hardware-based processor which can be configured to perform one or more processing tasks (e.g., one or more updating-based tasks) based on the data signal(s) (e.g., corresponding to one or more OTA packages).

The third module 206 can correspond to a hardware-based module (e.g., a receiver) which can be configured to receive the data signal(s).

The present disclosure contemplates the possibility that the first and third modules 202/206 can, in one example, be an integrated software-based transceiver module (e.g., an electronic part which can carry a software program/algorithm in association with receiving and transmitting functions/an electronic module programmed to perform the functions of receiving and transmitting).

The present disclosure contemplates the possibility that the first and third modules 202/206 can, in another example, be an integrated hardware-based transceiver module configured to perform the functions of receiving and transmitting.

The present disclosure contemplates the possibility that the first and third modules 202/206 can, in yet another example, be an integrated transceiver module (i.e., configured to perform the functions of receiving and transmitting) which is based on a combination of a software-based module and a hardware-based module.

In view of the foregoing, it is appreciable that the present disclosure generally contemplates, in one embodiment, an apparatus 102 which can, for example, be suitable for use with a vehicle (not shown). In one example, there is provided an apparatus 102 which can be suitable for use for updating a vehicle (not shown), in accordance with an embodiment of the disclosure. In a more specific example, there is provided an apparatus 102 which can be suitable for updating a vehicle (not shown) during the vehicle ignition off state, in accordance with an embodiment of the disclosure.

The apparatus 102 can initially be in a power saving mode when the vehicle is in the ignition off state. Moreover, the apparatus 102 can be configured to switch between a wake-up mode and the power saving mode. It is appreciable that in the power saving mode, for example, current consumption can be lower as compared to, for example, current consumption during the wake-up mode. In this regard, it is appreciable that, for example, current consumption, during the power saving mode, can be considered to be reduced (i.e., as compared with \ current consumption during the wake-up mode).

The apparatus 102 can include a first module 202 and a second module 204, in accordance with an embodiment of the disclosure. The first module 202 can be coupled to the second module 204.

The first module 202 can be configured to communicate one or more request signals when the apparatus 102 is switched from the power saving mode to the wake-up mode. Based on the request signal(s), availability of at least one update package can be determined. When availability of an update package is determined (e.g., one or more update packages are available for download), one or more data signals corresponding to the update package can be communicated. When unavailability of an update package is determined (e.g., it is determined that there are no update packages for download), the apparatus 102 can be switched from the wake-up mode to the power saving mode.

The second module 202 can be configured to process the data signal(s), when availability of an update package is determined, in a manner so that the vehicle can be updated.

Moreover, the apparatus 102 can be configured to switch from the wake-up mode to the power saving mode after the vehicle has been updated. In one embodiment, the apparatus 102 can be switched between the power saving mode and the wake-up mode periodically (e.g., based on a predetermined time-period/frame) initially (e.g., for the purpose of waking up periodically to communicate the request signal(s)).

It is contemplated that the apparatus 102 can be coupled to a device 104 (e.g., a backend server) which can be capable of carrying at least one update package. The request signal(s) can be communicated from, for example, the first module 202 to the device 104. Based on the request signal(s), the device 104 can be configured to communicate the update package(s), if there are one are more update packages available for download. In one embodiment, the update package(s) can be communicated via a communication network 106, for example, through an authenticated access point (not shown). The communication network 106 can, for example, correspond one or both of a cellular-based network and a Wi-Fi-based network (i.e., a cellular-based network and/or a Wi-Fi based network).

In the above manner, it is appreciable that updating can possibly be facilitated/performed during the time/period when a vehicle engine is turned/switched off (i.e., “ignition off”). Hence, updating need not necessarily be performed whilst the vehicle engine is turned/switched on (i.e., during “ignition on”) and vehicle functionality/functionalities whilst vehicle is in operation (e.g., when being driven) would not be necessarily be substantially adversely affected/impacted. In this regard, it is appreciable that updating can possibly be performed/facilitated in a (more) user friendly manner. Moreover, updating can be performed without the vehicle engine being left idling and, hence, updating can possibly be performed in a (more) efficient manner (e.g., in a more fuel/energy efficient manner).

Moreover, in the above manner (e.g., based on appropriate switching between the power saving mode and the wake-up mode), it is contemplated that current consumption during updating whilst “ignition off” can possibly be at least substantially reduced. Hence, the possibility of the vehicle battery being depleted during updating (e.g., due to high current consumption during updating) whilst “ignition off” can at least be substantially reduced.

The above-described advantageous aspect(s) of the apparatus 102 of the present disclosure can also apply analogously (all) the aspect(s) of a below described processing method 300 of the present disclosure. Likewise, all below described advantageous aspect(s) of the processing method 300 of the disclosure can also apply analogously (all) the aspect(s) of above described apparatus 102 of the disclosure. It is to be appreciated that these remarks apply analogously to the earlier discussed system 100 of the present disclosure.

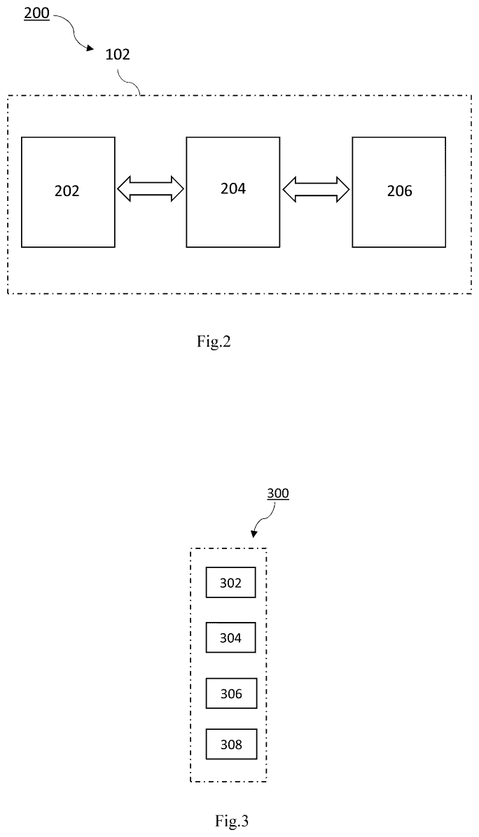

Referring to FIG. 3, a processing method 300 in association with the system 100 is shown, according to an embodiment of the disclosure.

The processing method 300 can be associated with performing one or more tasks of updating, in accordance with an embodiment of the disclosure. Specifically, the processing method 300 can be associated with updating a vehicle (not shown) whilst the vehicle is in an “ignition off” state.

The processing method 300 can include any one of a determination step 302, a receiving step 304, an updating step 306 and a power conservation step 308, or any combination thereof, in accordance with an embodiment of the disclosure.

In one embodiment, the processing method 300 can include a determination step 302, a receiving step 304, an updating step 306 and a power conservation step 308. In another embodiment, the processing method 300 can include a determination step 302, a receiving step 304 and a power conservation step 308. It is contemplated that, in one embodiment, the updating step 306 can possibly/potentially be omitted if, for example, no update packages are available.

With regard to the determination step 302, the request signal(s) can be communicated from the apparatus(es) 102. Availability of one or more update packages can be determined based on the request signal(s). For example, when the vehicle is in an “ignition off” state, the apparatus(es) 102 can initially be in a DRX mode. The apparatus(es) 102 can, for example, be configured to periodically awake from the DRX mode to communicate the request signal(s). In one embodiment, based on the request signal(s), a check can be performed to determine whether one or more update packages are available (i.e., for download).

With regard to the receiving step 304, the data signal(s) (i.e., corresponding to one or more update packages) can be received by the apparatus(es) 102 for processing if at least one update package is available for download. The data signal(s) can, for example, be processed in association with the vehicle update, in accordance with an embodiment of the disclosure. Such processing can, for example, relate to unpacking, compiling and/or formatting, if necessary, the downloaded update package(s), in accordance with an embodiment of the disclosure.

With regard to the updating step 306, updating can be performed (e.g., by the apparatus(es) 102) based on the received data signal(s). Specifically, updating of the vehicle can be performed. For example, one or more portions of the vehicle operating system can be updated, in accordance with an embodiment of the disclosure. In a more specific example, software associated with the vehicle can be updated, in accordance with an embodiment of the disclosure. Appreciably, updating of a vehicle can be performed by manner of, for example, updating one or more portions of the vehicle operating system and/or updating software associated with the vehicle, in accordance with an embodiment of the disclosure.

It is contemplated that the power conservation step 308 can relate to switching between operation modes. For example, a vehicle can be associated with one or more operation modes. The operation mode(s) can, for example, relate to one or both of the aforementioned wake-up mode and the aforementioned power-saving mode (i.e., wake-up mode and/or power-saving mode). For example, the power conservation step 308 can, for example, relate to the apparatus(es) 102 returning to the DRX mode if there are no available update packages for download or if vehicle updating has been completed.

In view of the foregoing, it is appreciable that the present disclosure generally contemplates, in one embodiment, a processing method 300 suitable for use with a vehicle (not shown). In an example, the processing method 300 can be used for updating a vehicle (not shown), in accordance with an embodiment of the disclosure. In a more specific example, the processing method 300 can be suitable for use for updating a vehicle (not shown) during the vehicle ignition off state.

The processing method 300 can include any one of a determination step 302, a processing step 304 and a power conservation step 308, or any combination thereof. In one embodiment, the processing method 300 can include a determination step 302, a processing step 304 and a power conservation step 308.

The determination step 302 can include communicating one or more request signals. The request signal(s) can, for example, be communicated by the first module 202 of the earlier mentioned apparatus 102. Based on the at least one request signal, availability of one or more update packages can be determined (e.g., whether one or more update packages are available for download). When it can be determined that at least one update package is available (e.g., for download), one or more data signals corresponding to the update package(s) can be communicated. In one embodiment, the apparatus 102 can, for example, initially in a power saving mode when the vehicle is in the ignition off state. Moreover, in one embodiment, the apparatus 102 can, for example, be configured to switch between a wake-up mode and the power saving mode. In one embodiment, the first module 202 can be configured to communicate the request signal(s) when the apparatus 102 is switched from the power saving mode to the wake-up mode.

The processing step 304 can include processing the data signal(s) in a manner so that the vehicle can be updated, if it is determined that one or more update packages are available. The data signal(s) can, for example, be processed by the second module 204 of the earlier mentioned apparatus 102.

The power conservation step can include switching between the wake-up mode and the power saving mode so as to reduce current consumption in connection with vehicle update during the vehicle ignition off state.

In one embodiment, the processing method 300 can further include an updating step 306 which can include updating the vehicle based on the data signal(s) if at least one update package is determined to be available.

i.

Moreover, in one embodiment, the update package(s) can be communicated via a communication network 106, for example, through an authenticated access point. The communication network 106 can, for example, correspond to one or both of a cellular-based network and a Wi-Fi-based network (i.e., a cellular-based network and/or a Wi-Fi-based network), in accordance with an embodiment of the disclosure.

The present disclosure further contemplates a computer program (not shown) which can include instructions which, when the program is executed by a computer (not shown), cause the computer to carry out any one of, or any combination of, the determination step 302, the processing step 304 and the power conservation step 308 (and, optionally, the updating step 306), as discussed with reference to the processing method 300.

The present disclosure yet further contemplates a computer readable storage (not shown) medium having data stored therein representing software executable by a computer (not shown), the software including instructions, when executed by the computer, to carry out any one of, or any combination of, the determination step 302, the processing step 304 and the power conservation step 308 (and, optionally, the updating step 306), as discussed with reference to the processing method 300.

In the above manner, it is appreciable that updating can possibly be facilitated/performed during the time/period when a vehicle engine is turned/switched off (i.e., “ignition off”). Hence, updating need not necessarily be performed whilst the vehicle engine is turned/switched on (i.e., during “ignition on”) and vehicle functionality/functionalities whilst vehicle is in operation (e.g., when being driven) would not be necessarily be substantially adversely affected/impacted. In this regard, it is appreciable that updating can possibly be performed/facilitated in a (more) user friendly manner. Moreover, updating can be performed without the vehicle engine being left idling and, hence, updating can possibly be performed in a (more) efficient manner (e.g., in a more fuel/energy efficient manner).

Moreover, in the above manner (e.g., based on appropriate switching between the power saving mode and the wake-up mode), it is contemplated that current consumption during updating whilst “ignition off” can possibly be at least substantially reduced. Hence, the possibility of the vehicle battery being depleted during updating (e.g., due to high current consumption during updating) whilst “ignition off” can at least be substantially reduced.

It should be appreciated that the embodiments described above can be combined in any manner as appropriate (e.g., one or more embodiments as discussed in the “Detailed Description” section can be combined with one or more embodiments as described in the “Summary of the Invention” section).

It should be further appreciated by the person skilled in the art that variations and combinations of embodiments described above, not being alternatives or substitutes, may be combined to form yet further embodiments.

In one example, the communication network 106 can possibly/potentially be omitted, in accordance with an embodiment of the disclosure. Communication (i.e., between the apparatus(es) 102 and/or the device(s) 104 can be by manner of direct coupling. Such direct coupling can be by manner of one or both of wired coupling and wireless coupling.

In another example, earlier mentioned, in an example implementation, upon completion of software download (i.e., fulfillment of the software download request), the DCM can enter a “power saving” mode by manner of disabling unnecessary functions (e.g., Wi-Fi connection) and, for example, returning to the DRX mode. It is further contemplated that the DCM can possibly, in another example, enter (i.e., switch to) power saving mode by manner of disabling all functions including Wi-Fi, with the exception that a modem (not shown) carried by, for example, the apparatus(es) 102 enters connected DNO (Digital Network Only) mode in order to keep low power consumption, in accordance with an embodiment of the disclosure.

In yet another example, earlier mentioned, in an example implementation, if it is determined that at least one OTA package is available for download, it can be determined that an OTA update would be required and the DCM can then be configured to enable communication via a Wi-Fi-based network via an authenticated AP. It is contemplated that the DCM can, in an example, be configured to enable communication directly via a cellular network (e.g., for downloading an OTA package) instead of enabling communication via a Wi-Fi-based network. It is also contemplated that the DCM can, in another example, be configured to enable communication (e.g., for downloading an OTA package) via a combination of the Wi-Fi-based network and the cellular-based network.

In the foregoing manner, various embodiments of the disclosure are described for addressing at least one of the foregoing disadvantages. Such embodiments are intended to be encompassed by the following claims, and are not to be limited to specific forms or arrangements of parts so described and it will be apparent to one skilled in the art in view of this disclosure that numerous changes and/or modification can be made, which are also intended to be encompassed by the following claims.

1. An apparatus suitable for use for updating a vehicle during a vehicle ignition off state, the apparatus being initially in a power saving mode when the vehicle is in the ignition off state and configurable to switch between a wake-up mode and the power saving mode, the apparatus comprising:
a first module configurable to communicate at least one request signal when the apparatus is switched from the power saving mode to the wake-up mode,
wherein based on the at least one request signal, availability of at least one update package is determined,
wherein when availability of an update package is determined, at least one data signal corresponding to the update package is communicable, and
wherein when unavailability of an update package is determined, the apparatus is switched from the wake-up mode to the power saving mode; and
a second module coupled to the first module, the second module configurable to process the at least one data signal in a manner so that the vehicle is updatable, when availability of an update package is determined, the apparatus being configurable to switch from the wake-up mode to the power saving mode after the vehicle has been updated,
wherein the apparatus is initially switched between the power saving mode and the wake-up mode in a periodic manner.

2. The apparatus according to claim 1, wherein the apparatus is coupled to a device capable of carrying at least one update package.

3. The apparatus according to claim 2,
wherein the at least one request signal is communicable from the first module to the device, and
wherein based on the at least one request signal, the device is configurable to communicate, if available, the at least one update package.

4. The apparatus according to claim 1, wherein the at least one update package is communicable via a communication network through an authenticated access point.

5. The apparatus according to claim 4, wherein the communication network corresponds to at least one of a cellular-based network and a Wi-Fi-based network.

6. A processing method usable for updating a vehicle during a vehicle ignition off state, the processing method comprising:
a determination step comprising communicating, by a first module of an apparatus, at least one request signal, and based on the at least one request signal, availability of at least one update package is determined,
wherein when availability of an update package is determined, at least one data signal corresponding to the update package is communicable,
wherein the apparatus is initially in a power saving mode when the vehicle is in the ignition off state and the apparatus is configurable to switch between a wake-up mode and the power saving mode,
wherein the apparatus is initially switched between the power saving mode and the wake-up mode in a periodic manner, and
wherein the first module is configurable to communicate the at least one request signal when the apparatus is switched from the power saving mode to the wake-up mode;
a processing step comprising processing, by a second module of the apparatus, the received at least one data signal in a manner that the vehicle is updatable, if at least one update package is determined to be available; and
a power conservation step comprising switching between the wake-up mode and the power saving mode so as to reduce current consumption in connection with vehicle update during the vehicle ignition off state.

7. The processing method as in claim 6, further comprising an update step, the update step comprising updating the vehicle based on the at least one data signal if at least one update package is determined to be available.

8. The processing method according to claim 7, wherein the at least one update package is communicable via a communication network through an authenticated access point.

9. The processing method according to claim 8, wherein the communication network corresponds to at least one of a cellular-based network and a Wi-Fi-based network.

10. (canceled)

11. A computer readable storage medium having stored thereon computer executable instructions that, when executed by a computer, perform operations for updating a vehicle during a vehicle ignition off state, the operations comprising:
determining, by communicating at least one request signal, and based on the at least one request signal, a availability of at least one update package;
initially switching between a power saving mode and a wake-up mode in a periodic manner;
communicating the at least one request signal when switching from the power saving mode to the wake-up mode; and
switching between the wake-up mode and the power saving mode so as to reduce current consumption in connection with vehicle update during the vehicle ignition off state.

12. The computer readable storage medium of claim 11, having stored thereon computer-executable instructions for performing further operations comprising: updating the vehicle based on the at least one data signal if at least one update package is determined to be available.

13. The computer readable storage medium of claim 7, wherein the at least one update package is communicable via a communication network through an authenticated access point.

14. The computer readable storage medium of claim 8, wherein the communication network corresponds to at least one of a cellular-based network and a Wi-Fi-based network.
